(19) United States
(12) Patent Application Publication
(10) Pub. No.: US 2022/0345431 A1
(43) Pub. Date: Oct. 27, 2022

(54) AUGMENTED REALITY PUBLIC MESSAGING EXPERIENCE

(71) Applicant: FABRIC GLOBAL OBC, Pasadena, CA (US)

(72) Inventors: Saul Garlick, Pasadena, CA (US); Sarah Kass, Jerusalem (IL); Uri Inks, Mazkeret Batia (IL); Moïse Cohen, Tel Aviv (IL)

(21) Appl. No.: 17/761,582

(22) PCT Filed: Sep. 21, 2020
(86) PCT No.: PCT/US2020/051832

§ 371 Date: Mar. 17, 2022

Related U.S. Application Data
(60) Provisional application No. 62/903,396, filed on Sep. 20, 2019.

(51) Int. Cl. H04L 51/222; G06T 11/00; H04W 4/021

(52) U.S. Cl. CPC H04L 51/222; G06T 11/00; H04W 4/021; G06Q 50/01

(57) ABSTRACT

There is disclosed a public messaging service which employs augmented reality as a display and navigation method. Users are able to tether their messages to either geographical locations or their mobile device. These messages may then only be viewed by other users in a close proximity. The usage of augmented reality allows not only for discourse in the virtual space as in traditional social media, but also facilitates real world conversations by acting as a virtual icebreaker.

### CROSS-REFERENCE TO RELATED APPLICATION

This application claims the benefit of priority to U.S. Provisional Patent Application No. 62/903,396 filed Sep. 20, 2019, entitled “Augmented Reality Public Messaging Experience”, the disclosure of which is hereby incorporated by reference in its entirety.

### TECHNICAL FIELD

The present disclosure generally relates to augmented reality (“AR”) as applied to a public messaging service.

### BACKGROUND

The use of augmented reality for messaging and social media is known in the art. Prior examples have focused on content posted on a surface in a style like graffiti or animated content that appears in the viewer's environment regardless of location. Current AR social media applications continue to follow the basic framework of non-AR social media where AR is only providing a novelty interface for viewing.

The missed opportunity in these models is using AR to facilitate real world events in real-time such as conversations between strangers.

### BRIEF DESCRIPTION OF THE DRAWINGS

The accompanying drawings, which are incorporated in and form a part of the specification, illustrate the embodiments of the present disclosure and together with the written description serve to explain the principles, characteristics, and features of the present disclosure. In the drawings:

FIG. 1 depicts two users viewing a message tethered to a geographic location in accordance with an embodiment.

FIG. 2 depicts a user viewing a message tethered to another user's mobile device in accordance with an embodiment.

FIG. 3A depicts an illustrative example of a user viewing other nearby user posts from a bird's eye view in accordance with an embodiment.

FIG. 3B depicts an illustrative example of a user viewing other nearby user posts from a third person view in accordance with the embodiment of FIG. 3A.

FIG. 4A depicts an illustrative top down view of a user viewing nearby posts and the effects of clustering posts in accordance with an embodiment.

FIG. 4B depicts an illustrative top down view of a user viewing nearby posts and the effects of movement on clustering posts in accordance with an embodiment.

FIG. 5 illustrates a block diagram of an illustrative data processing system in which aspects of the illustrative embodiments are implemented.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

For the purpose of this disclosure, augmented reality, or AR, refers to the overlay of digital content onto a user's real-world view, or perspective, through the use of a camera or transparent display. It should be understood that the camera or display may be handheld, head-mounted, wearable, stationary, or any method that allows for a proper augmented reality experience.

The term poster, or posting party, herein refers to a user, or users, that create a post, message, or media creation within an embodiment. Similarly, the term viewer, as used herein, refers to a user, or users, that view a post. The term mobile device, as used herein, may include any device capable of displaying AR including smart phones or wearable AR display units. A multimedia message may be any combination of text, images, audio, video, and/or any other digital content that is posted or transmitted.

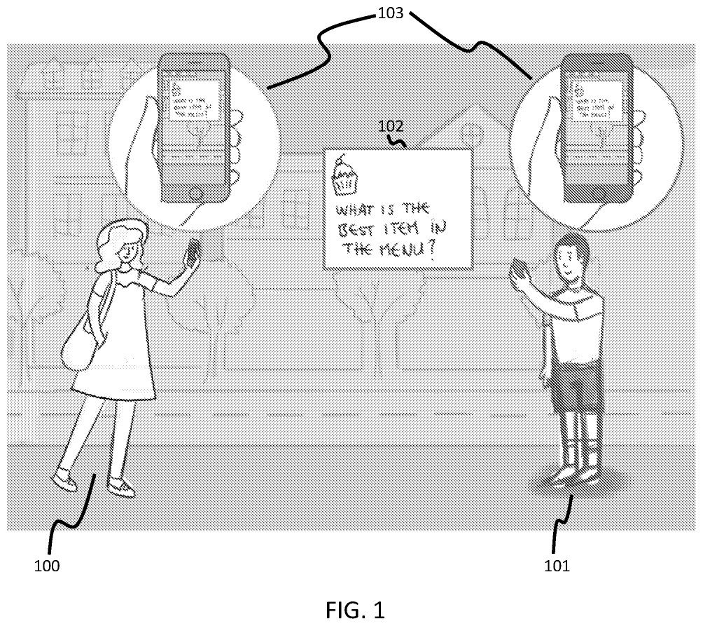

Referring now to FIG. 1, an example use case is shown for two users of an embodiment. In some embodiments, and as shown, the first user 100 may compose a multimedia message 102 (e.g., a text and/or image based message on their mobile device 103). The user 100 may then post the message 102 to a social media platform (e.g., Facebook, twitter, a built in platform, threads, or the like) or directly to other users. In a further embodiment, the message 102 may be tethered to a geolocation within their view (e.g., a bakery, store, restaurant, sporting event, etc.). In another embodiment, nearby user(s) 101 may then view the multimedia message on an AR display within their mobile device 103. In some embodiments, a geolocation-based post may be configured to appear against a wall, billboard, building entry, or any other location an advertisement may be visible, such as, for example, floating in space above a location.

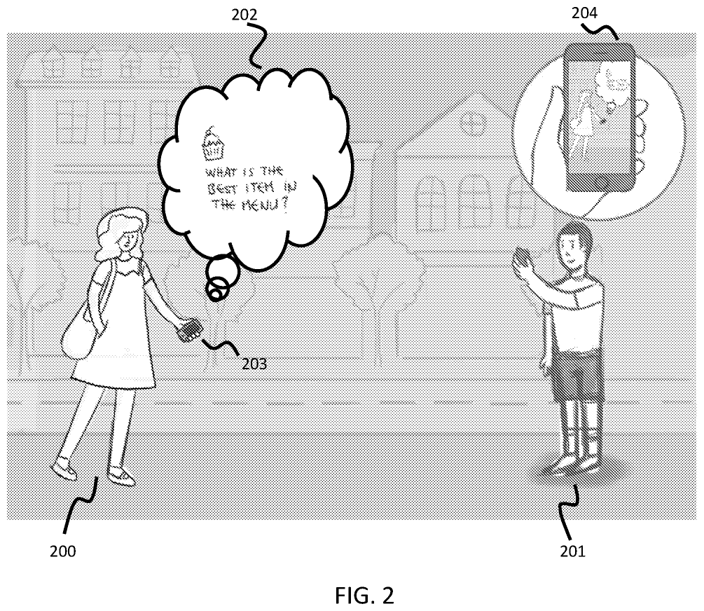

FIG. 2 illustrates another example embodiment, wherein a first user 200 has again composed a multimedia message 202. However, instead of associating the multimedia message with a specific geographic location, the user 200 may choose to tether the message 202 to their mobile device 203. Thus, as the user 200 carries their mobile device as they move around their environment, the message 202 will appear relative to the user's location. Thus, in some embodiments, if another user 201 was within a predetermined proximity to the first user 200, and their mobile device, they would be able to view the message 202 on their mobile device 204 through the AR display. In a further embodiment, the posted message 202 may continue to follow the geolocation of the user's 200 mobile device for a predetermined time period, and/or until the user deactivates the message.

In another embodiment, the user 200 may choose to tether the message 202 a different mobile device (not shown), or some other connected device. For example, if some embodiments, a user may tag or attach their message 202 to another object (e.g., another user's mobile device or any other object that has a network connection and an identifying feature). By way of non-limiting example, a user may be able to tag a message 202 to a float in a parade or a food truck. Thus, not only may a user 200 post a message associated with a location, they may also post a message associated with an object (e.g., mobile or non-mobile). In some embodiments, various methods of identification (e.g., a barcode, QR code, Radio Frequency Identification Tag, short and/or long range wireless communication, etc.) may be used by the user's mobile device to associate a post with the object, as well as ensuring the message updates its location as the object moves. In a further embodiment, the posted message 202 may continue to follow the geolocation of the object for a predetermined time period, and/or until the user deactivates the message.

Accordingly, in one or more embodiments, the user may be prompted to select a time—to-live (TTL) or decay factor that may be used to determine how and how quickly the post goes away. For example, in some embodiments, the post may fade or become smaller over time based on the decay factor or TTL. It should be understood that any other visual indicator may also be used, such as, but not limited to, losing color, fading, gradient fading, pattern animations, or the like. In a further embodiment, the foreground, background, text, and/or images may fade or dissipate at different rates. Thus, in some embodiments, a user may be able to select and/or determine how various factors are modified as the post goes away or is removed.

In some embodiments, a user may select a method of tethering their post through a various inputs (e.g., user input in a graphical user interface, gesture input, touchscreen pattern recognition, voice commands, etc.). For example, a user may drag a post into the AR space of their mobile device in order to tether the message to that location. Additionally or alternatively, a user may swipe up on a message to tether it to their mobile device. It should be understood that the above are very specific and non-limiting examples of how a user may interact with an embodiment. Various other input methods may be used, (e.g., shaking the device, rotating the device, having a stored preference, etc.).

In a further embodiment, a user may control or protect a certain geographical area. For example, a restaurant owner may be able to monitor and or control various aspects of how the system operates in their establishment. For example, a user may be able to restrict and/or control the number of messages, content of the messages, duration of messages, etc. associated with their restaurant. In some embodiments, the system may require some form of verification before allowing a specific user to obtain control over a geographic location. For example, a user may have to provide documentation proving they own the building or establishment they wish to control. In an alternative embodiment, a group of users may be able to elect or select a specific user who is given control over a geographic area for a period of time. Thus, if a community event, public/political rally, or the like is taking place, a large number of users may be able to create a controlled environment by selecting one or more users to give control of the access rights.

In another embodiment, the original poster or any viewers of the post may respond to with an additional multimedia message. In some embodiments, this may be done by selecting the post within the AR display and selecting a reply option. A user (e.g., new user or original user) may then be able to interact with the message and access additional information at the discretion of the original poster. In a further embodiment, the multimedia message may have additional information that comprises an extension of the posted topic, information on the poster, commonalities the system found between the poster and viewer, or the like.

In one embodiment, posts may be configured so that any user can view and/or respond if they are in geographic proximity to the post. In other embodiments, a user may be able to white and/or black list a user profile or a group of user profiles (e.g. a friend list, employee roster, etc.), thereby restricting their ability to view and/or respond. In a further embodiment, the system may include a further functionality that allows users to privately post and/or reply only to the poster.

In other embodiments, posts may only viewable by a particular subset of the user base (e.g., users belonging to a chosen user group of which the poster is a member, users who share various traits and/or hobbies with the user, etc.). In a further embodiment, a user, or users, may be able to automatically join a user group (e.g., based on their preferences and/or actions, such as, for example movement/location data, previously viewed posts/threads, etc.), request membership by another user, or by invitation only.

In some embodiments users may create their own group. In an embodiment a group may have a limited roster size. In an additional embodiment, a user may be able to numerically limit access to a post/thread/topic. For example, in one embodiment, a user may set a limit or cap on the number of users that can be granted access. In a further embodiment, it may be possible to limit use based on their access rights and/or privileges. For example, a user may set a limit on the number of people who can view a post versus the number or people who can comment and/or interact with the post. In a further embodiment, a user may require a new user have a “sponsor” or recommendation from an existing member or other recognized party.

In another embodiment, a user may require a certain number of users/members before a post, or part of a post (e.g., coupon code) is visible, or “goes live. By way of non-limiting example, a merchant, or retailer, may offer a discount or promotion to the first fifty (50) people who register with a post/thread/group. Thus, as already discussed the group has a cap of fifty (50) users. However, in an additional embodiment, the merchant may, for example, include a coupon code in the post that is not visible until all 50 slots in the promotion are full. In a further embodiment, a user may enable a “waitlist” feature, which would allow rejected users to create queue and perhaps receive access at a later point. In an additional embodiment, group formation or increased group roster size may be a premium service.

In most embodiments, users may belong to multiple user groups. When viewing their user groups, a user may be presented with other user groups with common membership. The usernames of these common users may be hidden unless the user belongs to both groups. In some embodiments, users posting or responding to a post may choose to display the user groups they have joined. In an embodiment a user may be able to see how many active users of a specific user group are nearby.

In some embodiments users automatically join a default group. It may be optional for users to leave the default group. The default group my optionally not display common users among other groups.

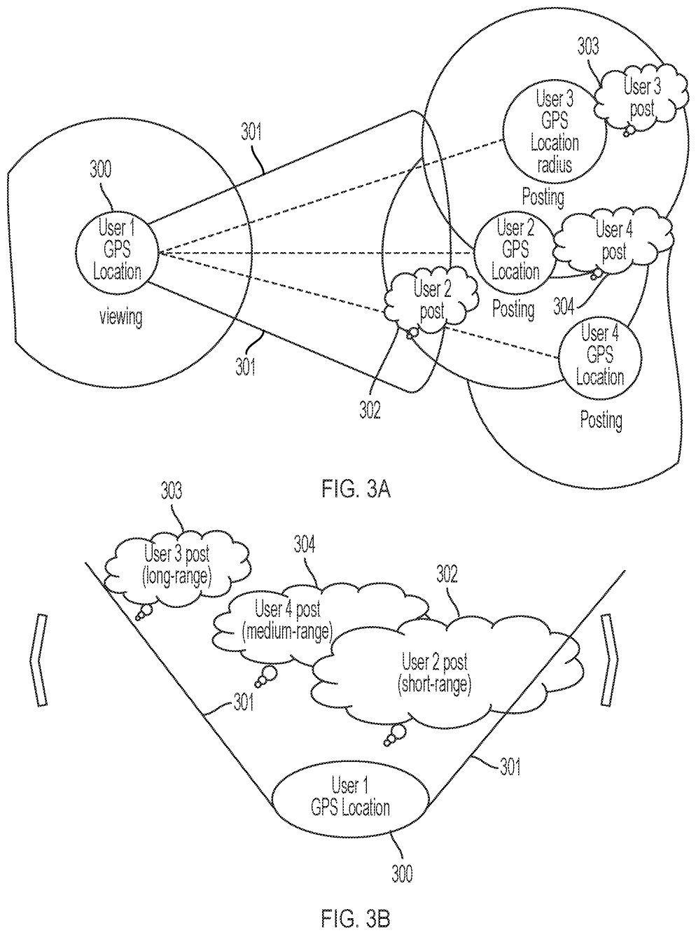

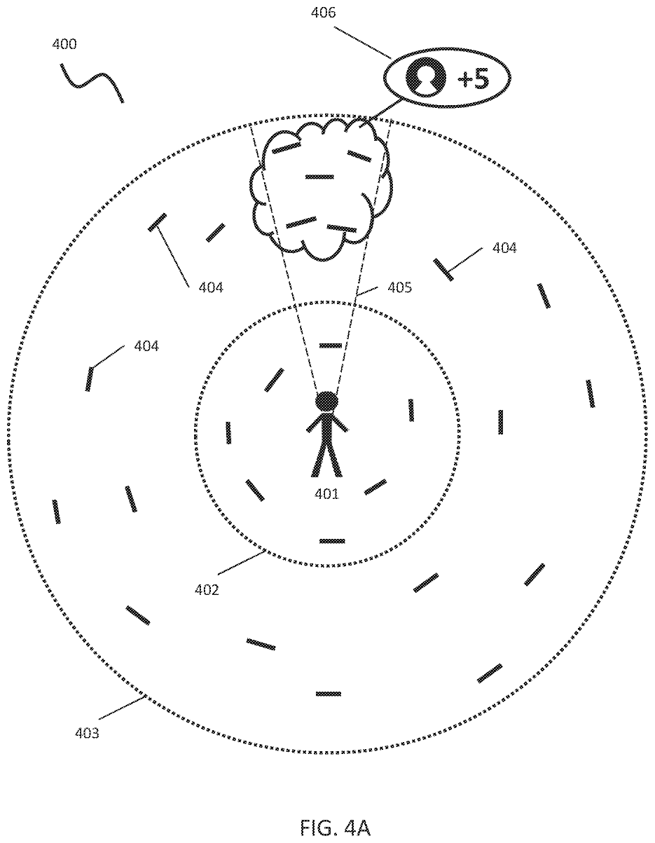

Referring now to FIGS. 3A and 3B, in accordance with an embodiment, and as shown, an example viewpoint of a user 300 from a birds-eye-view and third person view respectively, within the AR environment. Thus, in one embodiment, one or more users (e.g., user two, three, and four as shown) may have each made a multimedia message/post. In a further embodiment, and as discussed herein, the message/post may be tethered to a geolocation (e.g., user 2 GPS location, user 3 GPS location, user 4 GPS location, etc.).

In some embodiments, various characteristics (e.g., size, color, text size, image size, orientation, etc.) of a post 302/303/304 may be modified. The various characteristics may be modified based a plurality of factors, such as, for example, the number of replies in a thread, the amount of time since the message was created, the geolocation of the message, the relative distance of the message, etc.

As a specific non-limiting example, the various characteristic may be size, and the factor may be the relative distance of the message. Thus, briefly referring to FIG. 3A, in this non-limiting example, because user 2′s post 302 is physically closer to user 1 300, post 302 appears larger than post 303 and/or 304. In a further embodiment, user three's post 303 is the farthest away and thus would appear the smallest within the AR display to force perspective. As shown, user four's post 304 is at a distance in-between post 302 and 303, and takes a size in-between. In an additional embodiment, as shown, one post (e.g., user four's post 304) may be obscured by a second post (e.g., user 2′s post 302) due to being in direct line-of-sight from the viewer 300. Thus, it may be possible, in some embodiments, for one post to partially, or entirely, eclipse/obscure another.

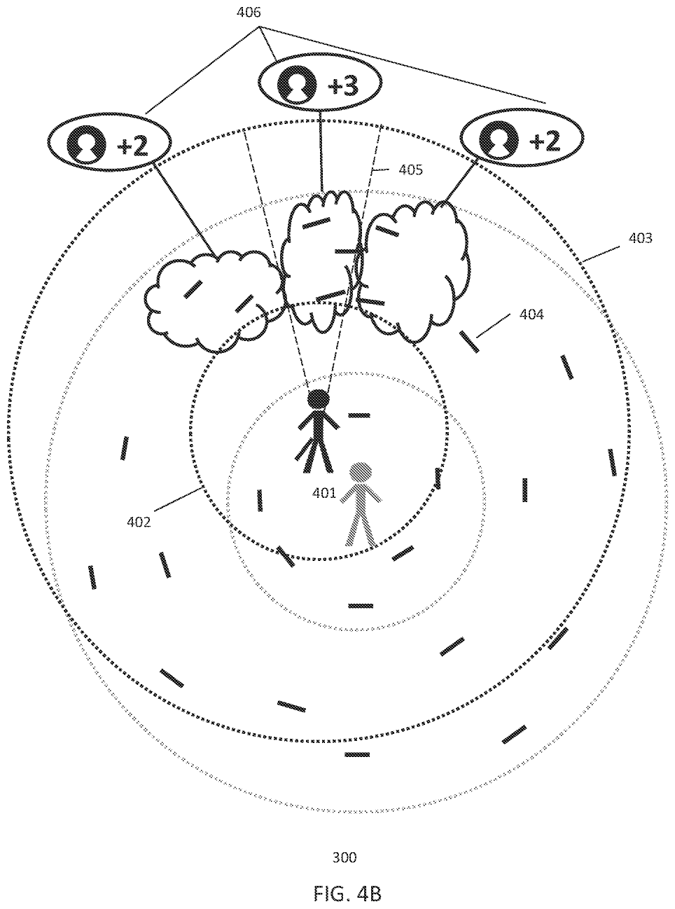

In some embodiments posts within in a specified distance to the user are visible. Posts outside that distance, but within the range of a larger specified distance may be clustered. In further embodiments the user may be able to interact with a cluster of posts to view the content of the contained posts. Referring briefly to FIG. 4A, an illustrative top down view an embodiment 400 shows of a user 401 viewing one or more posts 404. As shown, the user 401 can fully see all posts 404 within a given radius 402 (e.g. 10-100 meters).

In a further embodiment, one or more posts 404 outside the first radius 402 but inside one or more larger radii 403 (e.g., 50-500 meters) are visible to the user 404as one or more cluster 406. In some embodiments, clusters may be defined by subdividing the larger radii 403. For example, in one embodiment, the system may limit the view to a narrow angle, or line of site. A specified viewing angle 405 (e.g. 10° to 60° may cluster 406all posts 404 within that space as single virtual object. In some embodiments the virtual object representing a cluster 406 may contain shortened or abbreviated versions of the full post. In a further embodiment, a user may select the one or more of the posts 404 from within the cluster 406 to view further details.

Referring now to FIG. 4B, an embodiment is shown in which the user 401 has moved, relative to their location in FIG. 4A, to a new location. According to some embodiments, as the user 401 moves, their viewing angle 405 may dynamically shift to reassign, reorganize, and display one or more clusters 406 as one or more posts 404. In a further embodiment, the reassignment may also update any details displayed on each cluster 406.

In another embodiment, a viewer may customize how they view posts. In one non-limiting example, messages may be sized, highlighted, or colored according to the poster (e.g., a friend, family member, co-worker, etc.) or relevance of the post to the viewer (e.g. a topic the viewer has previously shown interest in). In some embodiments, as discussed herein, a user's post may also be rated as useful within the social medium. Thus, a poster's rating may also then be used as sorting method for viewing users.

In some embodiments, posts may be configured to automatically delete (e.g., disappear, etc.) based on one or more factors set up within the system. In some embodiments, the one or more factors may have been created and/or generated by one or more system administrations. In another embodiment, the one or more factors may have instead been created and/or generated by the poster or grouping of user (e.g., electing a person to set the one or more factors). Posts may, in some embodiments, delete after a specified time from posting or inactivity in response. Moreover, geo-located posts may delete if the poster leaves a specified area of proximity associated with the original message/post. In a further embodiment, one or more exemptions may be granted, optionally with an associated cost (e.g. a restaurant maintaining a post of its current menu at the place of business). In another embodiment, geolocation tracking may only be active when a user is actively sharing content. In a further embodiment, geolocation data relating to a user's post may only be shared with users in proximity to view the post. Moreover, in addition to the proximity requirement, a user may also blacklist or whitelist various user as well.

The disclosed system may exist as a standalone application or as part of a platform. In one embodiment, users may log onto the system with a username and password. In another embodiment, the username may be public, hidden, or a hybrid based on additional rules, such as those discussed herein. In some embodiments users may enter the AR space as a guest or visitor. Guests may have full user rights to post and view or may be limited to viewing only.

In accordance with an embodiment, the message/post, including the content and/or metadata (e.g., redirects and the message/post location are stored on one or more servers. The server may also store user and/or object geolocation data when available. Additional social data on each user, including typical information associated with a social media profile, may also be stored and/or utilized by some embodiments.

In another embodiment, a mobile device may use any communication interface to facilitate communication between the mobile device and the server. The communication interface can include both wired and wireless communication interfaces, such as Ethernet, IEEE 802.11 wireless, Bluetooth, or the like.

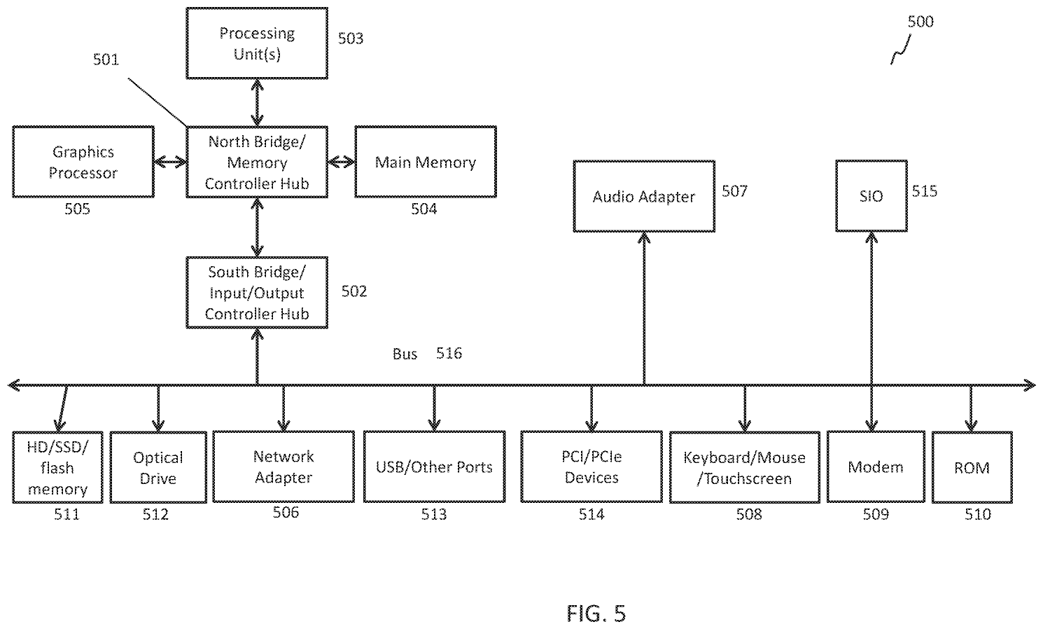

Referring now to FIG.5, a block diagram of an illustrative data processing system 500 in which aspects of the illustrative embodiments are implemented. The data processing system 500 is an example of a computer, such as a server or client, in which computer usable code or instructions implementing the process for illustrative embodiments of the present invention are located. In some embodiments, the data processing system 500 may be a server computing device. For example, the data processing system 500 can be implemented in a server or another similar computing device. The data processing system 500 can be configured to, for example, transmit and receive user information.

In the depicted example, data processing system 500 can employ a hub architecture including a north bridge and memory controller hub (NB/MCH) 501 and south bridge and input/output (I/O) controller hub (SB/ICH) 502. Processing unit 503, main memory 504, and graphics processor 505 can be connected to the NB/MCH 501. Graphics processor 505 can be connected to the NB/MCH 501 through, for example, an accelerated graphics port (AGP).

In the depicted example, a network adapter 506 connects to the SB/ICH 502. An audio adapter 507, keyboard, mouse, trackpad, or touchscreen adapter 508, modem 509, read only memory (ROM) 510, hard disk drive (HDD) 511, optical drive (e.g., CD or DVD) 512, universal serial bus (USB) ports and other communication ports 513, and PCl/PCIe devices 514 may connect to the SB/ICH 502 through bus system 516. PCl/PCIe devices 514 may include Ethernet adapters, add-in cards, and PC cards for notebook computers. ROM 510 may be, for example, a flash basic input/output system (BIOS). The HDD, SSD, or flash memory 511 and optical drive 512 can use an integrated drive electronics (IDE), serial advanced technology attachment (SATA) or embedded multimedia card (eMMC) interface. A super I/O (SIO) device 515 can be connected to the SB/ICH 502.

An operating system can run on the processing unit 503. The operating system can coordinate and provide control of various components within the data processing system 500. As a client, the operating system can be a commercially available operating system. An object-oriented programming system, such as the Java™ programming system, may run in conjunction with the operating system and provide calls to the operating system from the object-oriented programs or applications executing on the data processing system 500. As a server, the data processing system 500 can be an IBM® eServer™ System p® running the Advanced Interactive Executive operating system or the Linux operating system. The data processing system 500 can be a symmetric multiprocessor (SMP) system that can include a plurality of processors in the processing unit 503. Alternatively, a single processor system may be employed.

Instructions for the operating system, the object-oriented programming system, and applications or programs are located on storage devices, such as the HDD 511, and are loaded into the main memory 504 for execution by the processing unit 503. The processes for embodiments described herein can be performed by the processing unit 503 using computer usable program code, which can be located in a memory such as, for example, main memory 504, ROM 510, or in one or more peripheral devices.

A bus system 516 can be comprised of one or more busses. The bus system 516 can be implemented using any type of communication fabric or architecture that can provide for a transfer of data between different components or devices attached to the fabric or architecture. A communication unit such as the modem 509 or the network adapter 506 can include one or more devices that can be used to transmit and receive data.

Those of ordinary skill in the art will appreciate that the hardware depicted in FIG. 5 may vary depending on the implementation. Other internal hardware or peripheral devices, such as flash memory, equivalent non-volatile memory, or optical disk drives may be used in addition to or in place of the hardware depicted. Moreover, the data processing system 500 can take the form of any of a number of different data processing systems, including but not limited to, client computing devices, server computing devices, tablet computers, laptop computers, telephone or other communication devices, personal digital assistants, and the like. Essentially, data processing system 500 can be any known or later developed data processing system without architectural limitation.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A system for creating an augmented reality message comprising:
a processor associated with at least one user device; and
a non-transitory, processor-readable storage medium, wherein the non-transitory, processor-readable storage medium comprises one or more programming instructions that, when executed, cause the processor to:
receive, from the at least one user device, user input;
obtain, from the at least one user device, at least one device characteristic;
publish, based on the user input and the at least one device characteristic, an augmented reality message to an augmented reality social media environment at a specific geo-location, a decay factor of the published message is based on the user input; and
calculate a predetermined distance based on a density of user devices in a given area, the published message being viewable on at least one other user device within the predetermined distance from the specific geo-location.

2. The system claim 1, wherein the at least one device characteristic comprises a user geo-location of the user device.

3. The system of claim 2, wherein the one or more programming instructions that, when executed, cause the processor to: tether, based on the at least one user input, the published message to the user device.

4. The system of claim 3, wherein the one or more programming instructions that, when executed, cause the processor to:
obtain, from the at least one user device, GPS coordinates of the at least one user device; and
update, the specific geo-location of the published message to the GPS coordinates of the at least one user device.

5. The system of claim 1, wherein the one or more programming instructions that, when executed, cause the processor to: tether, based on the at least one user input, the published message to a networked device, wherein the networked device is different than the user device.

6. The system of claim 5, wherein the one or more programming instructions that, when executed, cause the processor to:
obtain, from the networked device, GPS coordinates of the networked device; and
update, the specific geo-location of the published message to the GPS coordinates of the networked device.

7. The system of claim 2, wherein the one or more programming instructions that, when executed, cause the processor to: tether, based on the at least one user input, the published message to the specific geo-location.

8. The system of claim 7, wherein the one or more programming instructions that, when executed, cause the processor to:
calculate the coordinates of the specific geo-location based on the GPS coordinates of the at least one user device, an orientation of the at least one user device, and an estimated distance between the at least one user device and the specific geo-location.

9. The system of claim 7, wherein the specific geo-location is identifiable by at least one of: a barcode, QR code, Radio Frequency Identification Tag, and short and long range wireless communication.

10. (canceled)

11. The system of claim 1, wherein the published message undergoes a change in presentation comprising at least one of size or color on the at least one other user device based on a distance between a user geo-location of the at least one other user device and the specific geo-location of the message.

12. The system of claim 11, wherein a secondary published message has a tethered geo-location between the at least one other user device and the published message and partially occludes view of the published viewable on the at least one other user device.

13. (canceled)

14. The system of claim 1, wherein the published message provides an offer to purchase on the at least one other user device in the augmented reality social media environment.

15. (canceled)

16. A system, comprising:
a non-transitory, processor-readable storage medium, wherein the non-transitory, processor-readable storage medium comprises one or more programming instructions that, when executed, cause the processor to:
receive, from a first user device, a first plurality of user inputs;
receive, from a second user device, a second plurality of user inputs;
receive first geo-location data from the first user device;
receive second geo-location data from the second user device;
publish, based on the first and second user inputs and the first and second geo-location data, a plurality of augmented reality messages to a social media environment at a specific geo-location;
calculate, based on the first and second geo-location data, a predetermined distance between the first and second user devices and the specific geo-location of each of the plurality of augmented reality messages;
determine, based on the predetermined distance, a relative visibility and size for each of the published plurality of augmented reality messages; and
publish the each of the published plurality of augmented reality messages to each of the plurality of user devices based on the relative visibility and size of each message.

17. The augmented reality social media of claim 16, wherein the plurality of augmented reality messages are clustered based on the predetermined distance and viewing angle within the first and second user devices.

18. A method of publishing augmented reality messages to a social media environment, comprising:
receiving a plurality of user inputs from a plurality of user devices at a server;
determining geo-location data corresponding to each of the plurality of user devices;
assigning the geo-location data to each of the plurality of user inputs based on the geo-location of the corresponding user device;
tethering an augmented reality message at a specific geo-location based on each of the plurality of user inputs and the assigned geo-location data;
calculating a distance between each of the plurality of user devices and the augment reality message;
calculating a density of the plurality of user devices in a specific area based on the distance;
determining a relative visibility and size of the augmented reality message for each of the plurality of user devices based on the distance and the density; and
publishing the augmented reality message to each of the plurality of user devices based on the relative visibility and size of the augmented reality message.

19. The method of claim 18, further comprising:
receiving movement data from each of the plurality of user devices;
updating the specific geo-location data based on the movement data; and
dynamically controlling the visibility and the size of the augmented reality message based on the movement data and density in the specific area.

20. The method of claim 19, further comprising providing a rating to each of the plurality of user devices of a usefulness of the augmented reality message within the social media environment.

21. The method of claim 20, further comprising:
providing rating data in response to the ratings; and
providing the rating data to only ones of the plurality of user devices in proximity to the specific area.
